(19) United States
(12) Patent Application Publication
(10) Pub. No.: US 2008/0216662 A1
(43) Pub. Date: Sep. 11, 2008

(54) Portable particulate-removing apparatus

(76) Inventors: Franklin Chongsuk Koh, Potomac, MD (US); Francis Huisuk Koh, Potomac, MD (US)

Correspondence Address: Randy C. Shay, 9707 Lawndale Drive, Silver Spring, MD, 20901, US

(21) Appl. No.: 12/009,478

(22) Filed: Jan. 18, 2008

Related U.S. Application Data
(60) Provisional application No. 60/881,445, filed on Jan. 19, 2007.

(51) Int. Cl. B01D 46/42; B01D 46/00

(52) U.S. Cl. 96/416

(57) ABSTRACT

A portable, self-contained air-purifying device that enables a person standing outside the device to use his hands to manipulate objects within the device so that those objects can be kept in particulate-free environment while being manipulated. The device includes a housing having a sealable opening, an airflow-generating device that circulates the air within the housing, an air filter, and manipulation structure configured to enable a person located outside said housing to use their hands to grasp and manipulate objects which have been placed within the chamber that has been subsequently sealed.

### FIELD OF THE INVENTION

The present invention relates generally to air filtration, and more specifically to a portable, self-contained air-purifying device where a person standing outside the device can use his hands to manipulate objects within the device so that those objects can be kept in a particulate-free environment while being manipulated.

### BACKGROUND OF THE INVENTION

Various types of glovebox-type apparatuses exist in the prior art. Examples of gloveboxes, fume hoods, chemical analyzer cabinets, containment vessels, isolation housings, and related enclosures are set forth in U.S. Pat. No. 3,777,736 (Van Der Waaij, et al.); U.S. Pat. No. 3,926,597 and U.S. Pat. No. 4,548,627 (Landy); U.S. Pat. No. 4,495,146 (Gheri); U.S. Pat. No. 4,662,231 (Schaarschmidt); U.S. Pat. No. 4,704,951 (Pruchon); U.S. Pat. No. 4,838,098 and U.S. Pat. No. 4,909,065 (Barney); and U.S. Pat. No. 5,083,558 (Thomas); U.S. Pat. No. 5,087,360 (Wright); U.S. Pat. No. 5,247,547 and U.S. Pat. No. 6,017,376 (Doig); U.S. Pat. No. 5,257,957 (Diccianni); U.S. Pat. No. 5,517,427 and U.S. Pat. No. 5,537,336 (Joyce); U.S. Pat. No. 5,558,112 (Strieter); U.S. Pat. No. 5,713,791 (Long); U.S. Pat. No. 5,716,525 (Nickerson); U.S. Pat. No. 5,730,765 (Henry, et al.); and U.S. Pat. No. 6,715,343. The foregoing patents are herein incorporated by reference in their entirety.

There is a need, however, for a portable apparatus that allows for manipulation of dust-sensitive equipment within a protected environment that filters dust and other particulates from the air within the apparatus.

### SUMMARY OF THE INVENTION

Portable electronic devices and equipment, such as digital SLR cameras, are being utilized in various environments and circumstances where manipulating particulate-sensitive parts of such equipment is made difficult or imprudent because of the risk of exposing these sensitive components to airborne particulates. Dust can interfere with electronic sensors, such as CMOS or CCD sensors of digital cameras, as well as interfere with the transmission of images through lenses. Any digital or optical equipment should avoid exposure to airborne particulates to maximize their functioning. Exchanging lenses in remote environments subjects components inside digital SLR type cameras and similar devices to dust and particulates. Likewise, exchanging watch batteries in an open environment also subjects the components inside of the watch to air-borne particulates that could damage delicate parts and components.

The present invention is a self-contained portable apparatus that purifies air inside an enclosable interior region of the housing unit, allowing for manipulation of equipment in essentially a dust-free environment, or restricting escape of particulates created by manipulation of objects inside the enclosed interior region. The housing can be made from a flexible material, such as fabric, or from a synthetic material, such as plastic, TPU/PVC or polyvinyl. Any flexible material capable of preventing particulate materials from passing through it would be suitable for use in making the housing. The material from which the housing is made can be completely transparent to allow visualization of objects placed inside. In the alternative, if the housing is made using a material that is translucent or opaque, a transparent window can be incorporated into a portion of the housing to allow visualization of the contents of the housing. An air-filtering device with a built-in air flow generating unit and filter are connected inside the interior region, the air filtering device purifying the interior region by way of a HEPA filter or other particulate-removing filter system. The invention further comprises structure that enables a person located outside the housing to use their hands to manipulate objects located inside the housing, the manipulation either involving direct contact manipulation, where the person's hands are inserted through respective openings on the housing wall so that they directly contact the object being manipulated, or indirect contact manipulation, where the person's hands are inserted into gloves which are formed within a wall of the housing and extend into interior region of the housing so that the hands of the person do not directly contact the objects to be manipulated, but instead manipulate the objects through the gloves. This indirect contact manipulation through gloves is sometimes called glovebox manipulation. Objects, such as digital cameras with interchangeable lenses, can be manipulated within the apparatus of the present invention to reduce the risk of damage to these sensitive items from dust and other particulates.

Additional features of the invention are as follows: The apparatus can either have a power cord to connect it to an external power source, or can be powered by a battery, which can optionally be rechargeable, either by plugging the battery into a recharger or by solar cells that can be incorporated into the exterior of the housing. The gloves, if used, can be detachably connected to the housing to enable soiled or damaged gloves to be easily replaced. Sealable flaps secured, respectively, to the inside and/or the outside of the housing of the apparatus can limit exposure and mobility of the gloves when they are not in use to protect them from damage and soiling. The invention can include an adaptor to enable attachment of the airflow-generating device to an object to be manipulated within the apparatus to enable the object attached in this way to be cleaned of particulates. Some or all of the housing can include padding, and the housing can contain a divider that creates separate compartments. The air-filtering device can be removable from the housing so that it can be used or stowed away separately. The apparatus can be collapsed and stowed away, when not in use, within a larger carrying case, such as a case commonly used to carry cameras, lenses, and other photography supplies.

It is therefore an object of the invention to provide a portable particulate-removing apparatus that is effective for filtering particulates from the air within the apparatus.

It is a further object of the invention to provide a portable particulate-removing apparatus that allows a user to manipulate objects within the housing of the apparatus.

It is a further object of the invention to provide versatility which allows the apparatus to function also as a rain cape or function as a waterproof housing for underwater photography.

It is a further object of the invention to provide a portable particulate-removing apparatus that is simple to manufacture, and is capable of being stored and transported easily.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference numerals designate the same or similar parts throughout the drawings, and wherein:

FIG. 1 is a perspective view of the apparatus showing the housing in an open position.

FIG. 2 is a perspective view of the apparatus showing the housing in a closed position and having optional handles, with objects to be manipulated visible within the closed housing.

FIG. 3 is a close-up perspective view of the air-filtering device.

FIG. 4 is a close-up front view of the air-filtering device with the HEPA filter partially removed.

FIG. 5 is a perspective view of the apparatus where the material of the housing is opaque and the housing contains a transparent window therein.

FIG. 6 is a perspective view of the apparatus where the housing has a viewing window therein and solar panels attached to the outside thereof.

FIG. 7 is a front view of the apparatus with an alternative arrangement for the gloves.

FIG. 8 is a view of a glove of the invention showing that it can be removably attached.

FIG. 9 is a perspective view of the apparatus showing an alternative to the glove that enables indirect contact manipulation of objects to be manipulated within the housing.

FIG. 10 is a perspective view of the invention showing exterior sealable flaps.

FIG. 11 is a perspective view of the invention showing interior sealable flaps.

FIG. 12 is a perspective view of the invention in a collapsed configuration for storage.

FIG. 13 is a perspective view of the invention with expandable openings to enable direct contact manipulation of objects to be manipulated within the housing.

FIG. 14 is a perspective view of exterior sealable flaps covering the expandable openings of FIG. 13.

FIG. 15 is front view of self-enclosing barriers which can fit snuggly around a wrist and arm inserted therethrough.

FIG. 16 is a cut-away view of one of the self-enclosing barriers of FIG. 15 fitted snuggly around the wrist and arm area, forming a seal from the exterior elements.

FIG. 17 is a top view of the airflow-generating device of the invention connected via an adaptor to an object to be cleaned.

FIG. 18 is a front view of the airflow-generating device, adaptor, and object to be cleaned of FIG. 17.

FIG. 19 is a perspective view of the apparatus in its expanded state with the air-filtering device of the invention contained within the housing.

FIG. 20 is a perspective view of the apparatus where the air-filtering device has been removed from the housing and the housing has been collapsed for storage.

FIG. 21 is a perspective view of the collapsed housing and air-filtering device being separately stored within a larger carry bag.

FIG. 22 is a top view of the device showing the housing interior being divided into compartments and showing padding on the wall of the housing.

FIG. 23 is a perspective view of the divider of FIG. 22 that removably attaches to the interior surface of the housing to create separate compartments.

FIG. 24 is a perspective view of the air-filtering device and the housing in a collapsed state being stored within a camera equipment bag.

FIG. 25 is a perspective view of another preferred embodiment of the invention where the housing features a lens port to receive the lens of a camera.

FIG. 26 is a perspective view of the embodiment of FIG. 25 with a camera contained within the housing and its lens inserted through the lens port.

FIG. 27 is a side view of an alternative variation of the lens port which has an expandable accordion structure and a lens port cap that is transparent.

FIG. 28. is a demonstrative illustration of the embodiment of FIG. 25 or 26 being used as a rain cape, covering the camera and the person to protect them from the rain while the person uses the camera to take photographs.

FIG. 29 is a perspective view of another preferred embodiment of the invention where the housing and glove ports and the connections therebetween are waterproof, enabling the user to use the camera underwater.

FIG. 30 is a perspective view of an alternative embodiment of the air-filtering device.

FIG. 31 is an exploded view of some of the major components of the air-filtering device of FIG. 30.

### DETAILED DESCRIPTION OF THE INVENTION

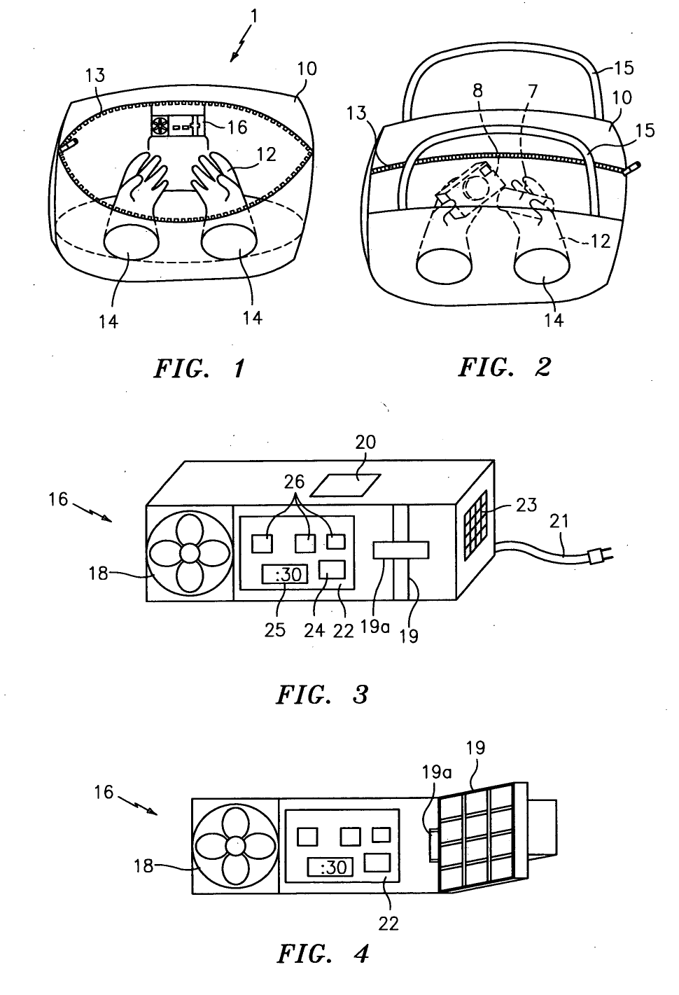

FIG. 1 shows a portable particulate-removing apparatus 1 having a housing 10, which is shown in an open position. The housing 10 can be made of any flexible material that may be transparent, translucent, or opaque provided that it is capable of preventing particulate materials from passing through it. The housing has a sealing device 13 that is capable of securing the housing 10 in a closed configuration, as shown in FIG. 2. The sealing device 13 is a conventional sealing device, such as a zipper or a Ziplock®-like device or other appropriate sealing device that is capable of releasably joining two sections along a seam, or a sealing device and structures that creates releasable waterproof seals.

Contained within housing 10 is an air-filtering device 16, to be discussed in more detail below. A wall of housing 10 contains two thin, flexible pocket-style manipulation ports in the shape of gloves 12 secured thereto and extending into the interior region of housing 10. By placing their hands in the openings 14 of respective gloves 12, a person located outside of apparatus 1 can manipulate objects positioned within the housing 10 with indirect contact through the gloves 12.

As shown in FIG. 2, with the sealing device 13 securing housing 10 in a closed configuration, objects, such as a digital SLR camera 8 and lens 7, contained within the housing 10 are in a protected state, shielded from exposure to the ambient air, being exposed only to the air that is contained within housing 10. This figure shows how, without comprising this protected state, a person is capable of manipulating these objects with indirect contact by placing their hands in the gloves extending into interior region of the housing 10. FIG. 2 also shows carrying straps, or handles 15 attached to housing 10, which are an optional feature of the apparatus to enable it to be easily carried.

FIG. 3 shows the details of the air-filtering device 16, which can be made to be detachable from the interior wall of housing 10. This device 16 includes an airflow-generating device 18, which can be a conventional motor-driven fan, and an air filter 19 retained within the air-filtering device by filter latch 19a. Air within housing 10 is caused to circulate by airflow-generating device 18. This draws the air into air-filtering device 16, which is directed via a channel through filter 19, which filters particulates from the air. The filtered air then exits air-filtering device 16 through exit port 23 which is shown, for illustrative purposes only, to be in a side wall of the air-filtering device. Device 16 further includes a control panel 22 which can include some or all of the following features: a light 24, a timer, 25, and buttons and indicators 26 useful to control the various components of device 16 or to indicate their status. Light 24 illuminates the interior of housing 10 to make it easier to see objects being manipulated therein. Timer 25, which controls the power to the airflow-generating device 18, can either be programmable to any desired time or it can be preset, whereby, once started, it will run for only a predetermined amount of time necessary to fully filter out all the particulate matter contained within the volume of air contained within housing 10. One of the indicators 26 can be a filter status indicator, which indicates that a sensor associated with filter 19 has sensed that the filter 19 is in need of replacement. It should be understood that the particular arrangement of the filter 19, airflow-generating device 18, light 24, timer 25, and buttons and indicators 26 on the air-filtering device 16 are merely illustrative. Their arrangement is discretionary, as understood by one of ordinary skill in the art. Further features that can be seen in FIG. 3 is the presence of a power cord 21 which can extend through an appropriate opening in a wall of housing 10 to be plugged into an external power source to power the air-filtering device 16 directly or to charge the battery that is concealed beneath battery cover 22 of the air-filtering device 16. Such a battery could be any conventional battery, including, but not limited to lithium ion, nickel cadmium, nickel metal hydride, or lead.

As seen in FIG. 4, filter 19 can be replaced as necessary by opening latch 19s and sliding filter 19 out. After sliding a new filter 19 into place within device 16, latch 19a would be closed to secure the new filter 19 into place.

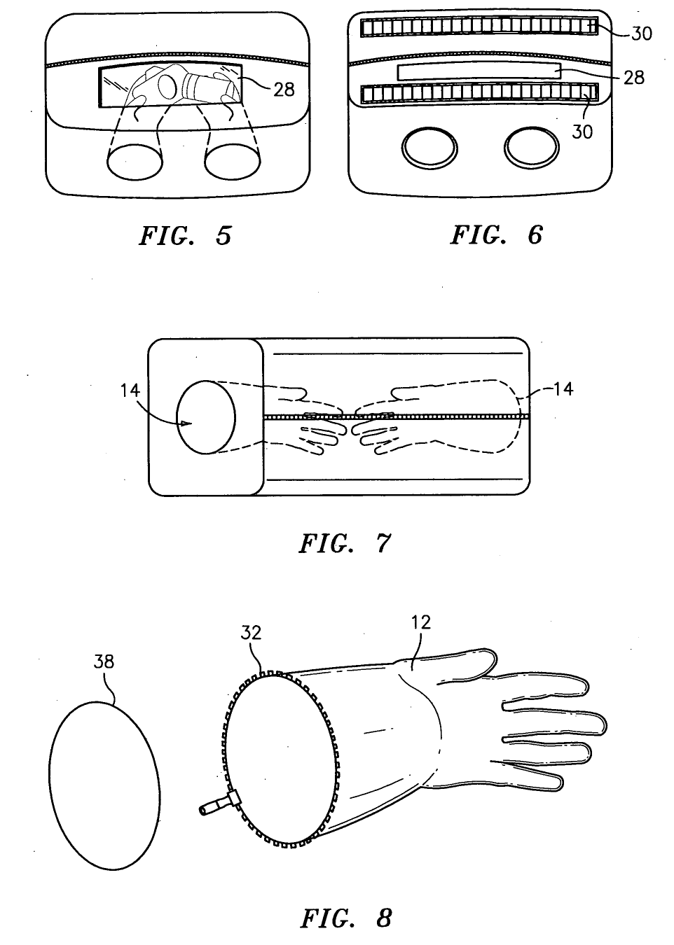

In the event that housing 10 is not made from a transparent material, a transparent viewing panel or window 28 can be included in the housing, as shown in FIG. 5. Window 28 can be any conventional transparent material, being either flexible or rigid. While window 28 is shown as being located in a top wall of housing 10, it should be understood that such a viewing window 28 could be placed on any portion of the housing 10 without departing from the scope of the invention.

FIG. 6 shows solar panels 30 located on the outside of housing 10. These solar panels 30 can be designed either to power the air-filtering device directly or to recharge the battery. Solar panels 30 can be any conventional solar panels, including flexible solar panels.

While the gloves 12 have been shown as located side by side on one wall of housing 10, these gloves 12 can be located at any position on housing 10 determined to be desirable, including, but not limited to, each glove 12 being located with its opening 14 on opposite end walls, respectively, of housing 10, as shown in FIG. 7.

In the event that one of the gloves 12 becomes soiled or damaged, it may be desirable to replace the glove 12 with a new one. For this reason, it is desirable to make the gloves 12 to be detachably mounted to housing 10. As can be seen in FIG. 8, glove 12 can have a glove linking structure 32 attached thereto that can removably secure to housing linking structure 33 attached to housing 10. This linking structure 32, 33 can be any suitable linking structure, such as hook and loop fasteners, a Ziploc® fastener, or a zipper, provided the linking structures, when joined, are capable of preventing particulate matter from passing therethrough. Furthermore, waterproof linking structures can also be used. When it becomes necessary to replace a glove 12, the linking structure 32 of the glove 12 to be removed is separated from the housing linking structure 33, the damaged glove is discarded, and the glove linking structure of a new glove 12 is attached to housing linking structure 33, thereby securing the new glove 12 in place. As an alternative to replacing one glove with another glove, it is also possible to replace a glove-shaped manipulation port with any other style of manipulation port. Additional styles of manipulation ports are described below.

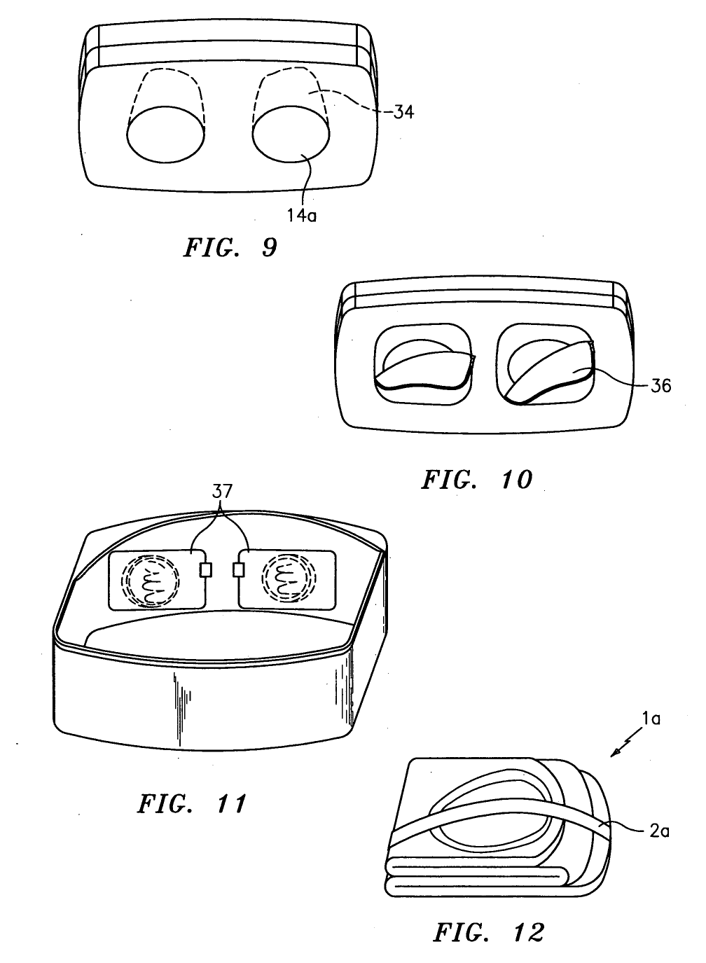

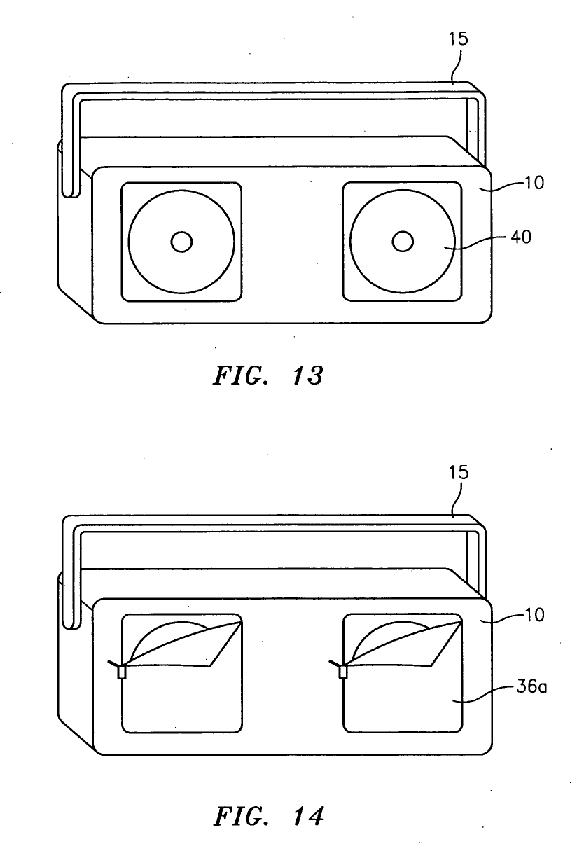

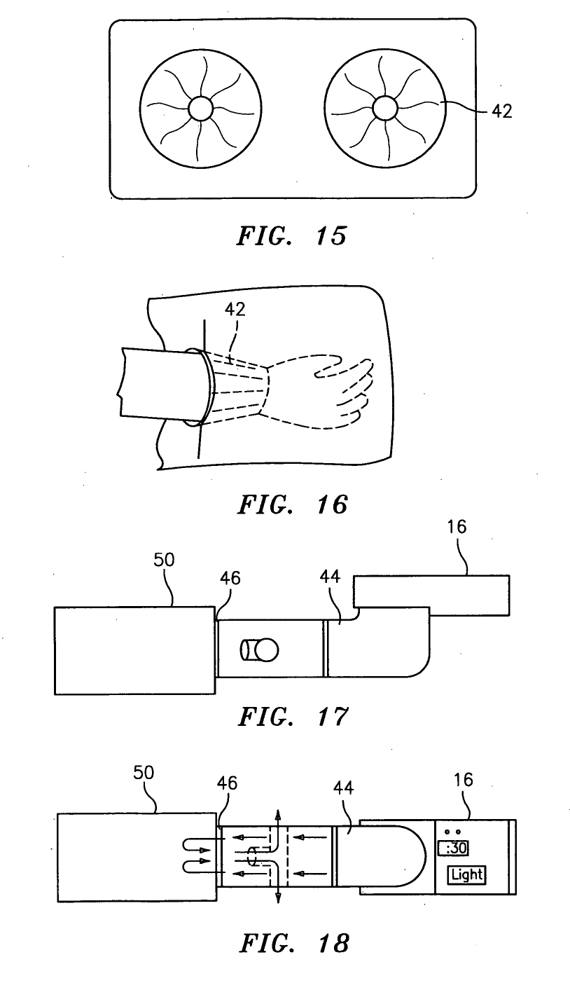

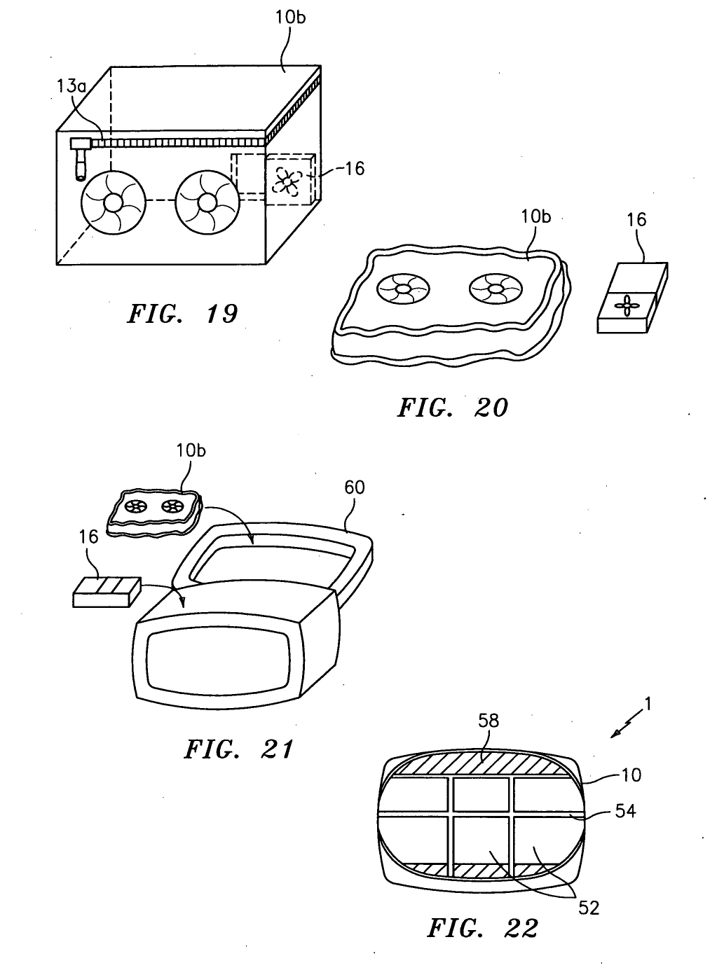

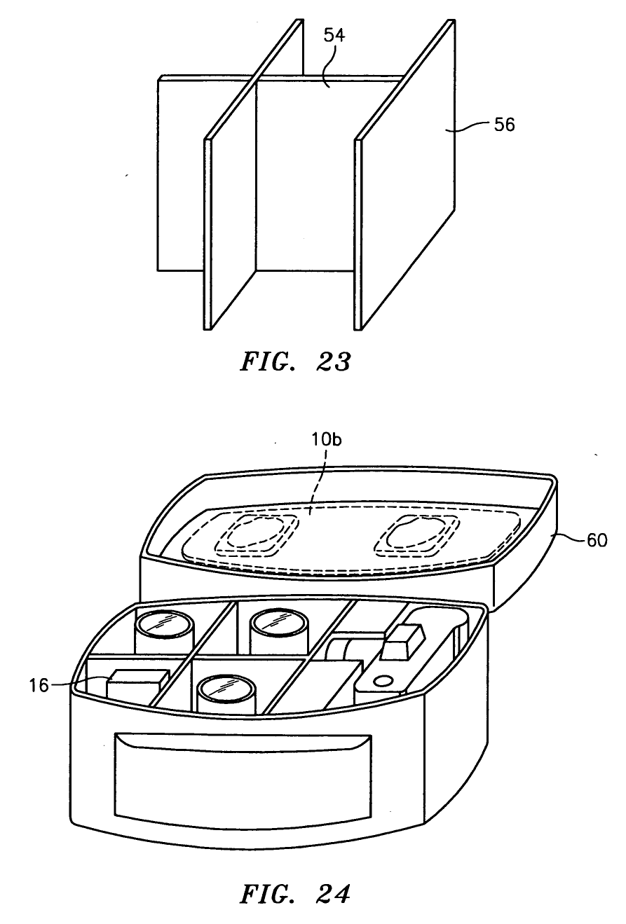

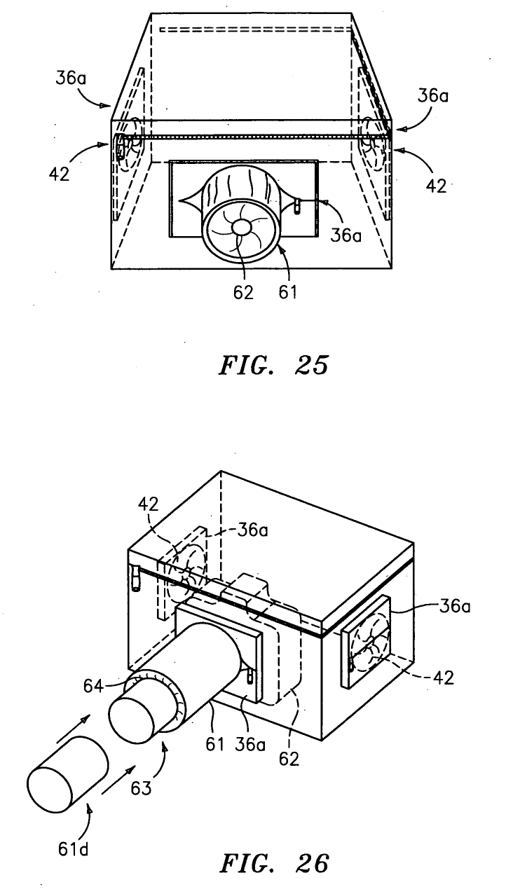

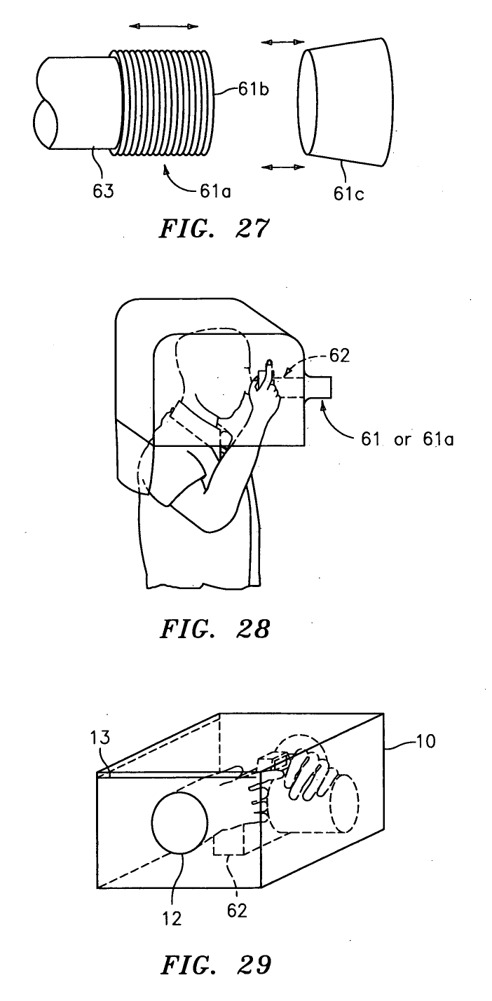

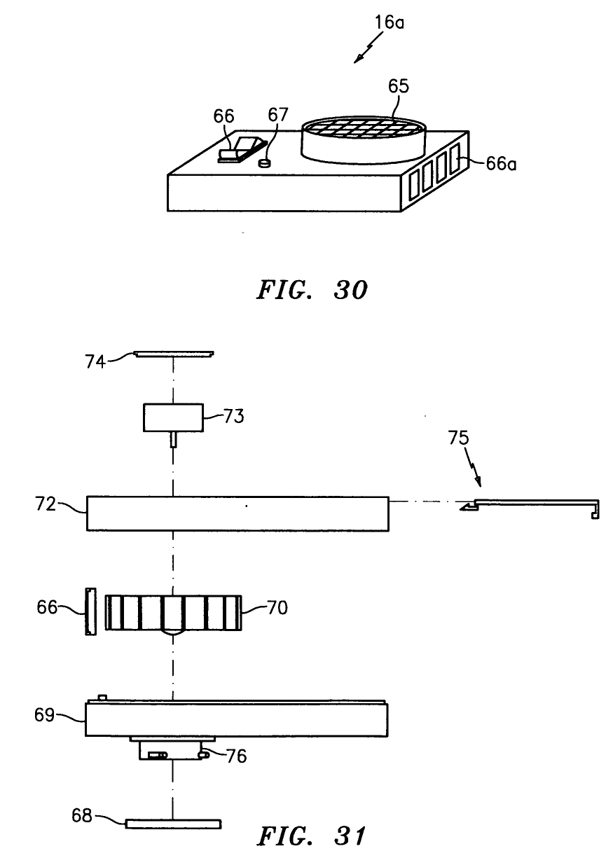

As an alternative to the standard glove shape 12, the thin, flexible pocket-style manipulation port structure that extends into housing 10 to enable indirect contact manipulation of objections within the housing can be of any suitable shape, such as in the form of pouches 34 shown in FIG. 9.

At times when the gloves 12 or their equivalent are not in use, in the interest of minimizing the chances of the gloves getting soiled or damaged or just getting in the way, the housing can include an interior sealing flap 36, as seen in FIG. 10, and/or an exterior sealing flap 37, as seen in FIG. 11. When both of these sets of sealing flaps 36, 37 are present and sealed closed, they form between them a storage pouch for storing the gloves 12 or their equivalent in a safe and secure manner.

FIG. 12 shows how the portable particulate-removing apparatus 1a can be folded down into a collapsed position, retained in that position by strap 2a.

FIG. 13 shows an alternative embodiment of the invention where instead of having manipulation ports in the form of gloves 12 extending into the interior region of housing 10, the housing 10 is provided with manipulation ports in the form of self-enclosing barriers 40 in one or more of the walls thereof. The self-enclosing barriers allow a user to insert their hands directly through a small, expandable opening in the barrier 40 to manipulate, through direct contact of the hands, an object within the housing 10 that is to be manipulated. The self-expanding barriers 40 are made of expandable material, such as rubber or silicon, or in combination with fabric or a similar expandable material, with a small opening of any shape that is capable to seal around the hands and arms of the user as he inserts his hands into the interior region of housing 10, thereby forming a seal with the user's arms and preventing particulate matter outside the housing

What is claimed is:

1. A portable air-filtering device enabling manipulation of objects within a sealed, particulate-free environment, the portable air-filtering device comprising:
a housing having a hollow interior chamber and having a sealable opening which can be opened to allow access to the interior chamber or closed to create an isolated environment within said housing,
an airflow-generating device that circulates air contained within the interior chamber;
an air filter contained within said chamber that filters particulates from the air inside the interior chamber as the air circulates through the filter,
manipulation structure configured to enable a person located outside said housing to use their hands to grasp and manipulate objects which have been placed within the chamber that has been subsequently sealed.

2. A portable air-filtering device enabling manipulation of objects within a sealed, particulate-free environment, as defined in claim 1, wherein at least one portion of said housing is transparent, thereby enabling the interior chamber to be seen from outside the housing while the sealable opening is in said closed position,

3. A portable air-filtering device enabling manipulation of objects within a sealed, particulate-free environment, as defined in claim 1, wherein said manipulation structure is removably secured to said wall of said housing to enable said manipulation structure to be removed and replaced with another manipulation structure.

4. A portable air-filtering device enabling manipulation of objects within a sealed, particulate-free environment, as defined in claim 3, wherein said manipulation structure comprises at least one pocket of a thin, flexible material for receiving the hand of a person, each said at least one pocket having an open end secured to a wall of said housing and having a closed end extending into the housing, enabling a person located outside said housing to insert a hand into one of said at least one pocket to grasp and manipulate, through the intervening thin, flexible material of the pocket, objects which have been placed within said interior chamber.

5. A portable air-filtering device enabling manipulation of objects within a sealed, particulate-free environment, as defined in claim 4, wherein said housing further includes at least one sealing element associated respectively with each said at least one pocket, said at least one sealing element comprising one of the group consisting of: an interior sealing element positioned and configured to selectively cover said respective pocket and isolate it from the inside chamber, an exterior sealing element positioned and configured to selectively cover said respective pocket and isolate it from ambient atmosphere that surrounds the housing, and a combination of an interior sealing element and an exterior sealing element positioned and configured to selectively contain said respective pocket between said interior sealing element and said exterior element and isolate said respective pocket from both the interior of the chamber and ambient atmosphere surrounding the housing.

6. A portable air-filtering device enabling manipulation of objects within a sealed, particulate-free environment, as defined in claim 1, wherein said airflow-generating device and said air filter are part of an air-handling unit, said air-handling unit further including a control panel which includes at least one of the group consisting of: a light, a timer which controls power to the airflow-generating device, and a filter sensor/indictor for detecting the status of the air filter and indicating when it is due for replacement.

7. A portable air-filtering device enabling manipulation of objects within a sealed, particulate-free environment, as defined in claim 6, wherein said air-handling unit is removably secured within said housing.

8. A portable air-filtering device enabling manipulation of objects within a sealed, particulate-free environment, as defined in claim 6, further comprising structure enabling said air-handling unit to be connected to an external power source.

9. A portable air-filtering device enabling manipulation of objects within a sealed, particulate-free environment, as defined in claim 6, further comprising a battery connected to power the components of the air-handling unit.

10. A portable air-filtering device enabling manipulation of objects within a sealed, particulate-free environment, as defined in claim 9, wherein said battery is rechargeable.

11. A portable air-filtering device enabling manipulation of objects within a sealed, particulate-free environment, as defined in claim 6, further comprising a solar power device connected to provide power to said air-handling unit.

12. A portable air-filtering device enabling manipulation of objects within a sealed, particulate-free environment, as defined in claim 1, wherein said airflow-generating device comprises an adaptor configured to connect the airflow generator to an object to be cleaned.

13. A portable air-filtering device enabling manipulation of objects within a sealed, particulate-free environment, as defined in claim 1, wherein at least a portion of said housing includes padding.

14. A portable air-filtering device enabling manipulation of objects within a sealed, particulate-free environment, as defined in claim 1, wherein said housing is collapsible from an open, operable configuration into a smaller, compact configuration for storage.

15. A portable air-filtering device enabling manipulation of objects within a sealed, particulate-free environment, as defined in claim 3, wherein said manipulation structure comprises at least one self-enclosing barrier, each said at least one self-enclosing barrier having an opening therein which has a minimal size when not in use, said opening being capable of expanding to accommodate insertion of a user's hand therethrough and providing a sealed engagement around the arm of any such hand which is inserted therethrough, and returning to its minimal size upon removal of the user's hand therefrom, whereby said at least one self-enclosing barrier enables a person located outside said housing to insert a hand though at least one said at least one self-enclosing barrier to directly manually grasp and manipulate objects which have been placed within said interior chamber of said housing.

16. A portable air-filtering device enabling manipulation of objects within a sealed, particulate-free environment, as defined in claim 15, wherein said housing further includes at least one exterior sealing flap associated respectively with each said at least one self-enclosing barrier, said at least one exterior sealing flap being positioned and configured to selectively cover said respective pocket and isolate it from ambient atmosphere that surrounds the housing,

17. A portable air-filtering device enabling manipulation of objects within a sealed, particulate-free environment, as defined in claim 1, further including a padded divider that divides the interior chamber into separate compartments.

18. A portable air-filtering device enabling manipulation of objects within a sealed, particulate-free environment, as defined in claim 1, wherein:
said housing includes a lens insert port which is configured to receive a lens of a camera when the camera is placed within the interior chamber of the housing, and
said sealable opening is large enough to permit a person's head to extend through said opening into said interior chamber,
thereby enabling a person to use said portable air-filtering device as a rain cape so they can take photographs in the rain by orienting the housing so that the sealable opening is on the underside of the housing, placing a camera in said interior chamber with its camera lens extending into said lens insert port, and lowering said housing over his or her head so that the housing protects all of the camera, the lens, and the person's head.

19. A portable air-filtering device enabling manipulation of objects within a sealed, particulate-free environment, as defined in claim 18, further comprising an exterior sealing flap positioned and configured to selectively cover said lens insert port and isolate it from ambient atmosphere that surrounds the housing.

20. A portable air-filtering device enabling manipulation of objects within a sealed, particulate-free environment, as defined in claim 18, further comprising a clear port cap secured to a distal end of said lens insert port.

21. A portable air-filtering device enabling manipulation of objects within a sealed, particulate-free environment, as defined in claim 20, further comprising a hood configured for attachment to said distal end of said lens insert port.

22. A portable air-filtering device comprising:
an airflow-generating device for circulating air,
an air filter operatively connected in the path of air circulated by said airflow-generating device,
a control console for controlling operation of said airflow-generating device.

23. A portable air-filtering device, as defined in claim 22, wherein said airflow-generating device further comprises an adaptor configured to connect the airflow generator to an object to be cleaned.

24. A portable chamber comprising:
a housing comprising a plurality of walls forming a chamber and a reclosable seal to provide selective access to said chamber,
at least one opening in at least one of said walls,
each of said at least one opening being surrounded by a connection element configured for interchangeably and securely attaching any one of a plurality of ports to the opening which it surrounds.

25. A portable chamber, as defined in claim 24, further comprising at least one thin, flexible, closed-end port connected to surround a respective one of each of said at least one opening by its associated connection element,
wherein said reclosable seal of said housing is a watertight seal, and each connection element provides a watertight connection between the housing and the port to which it is connected.
